(19) United States
(12) Patent Application Publication
(10) Pub. No.: US 2011/0135205 A1
(43) Pub. Date: Jun. 9, 2011

(54) METHOD AND APPARATUS FOR PROVIDING FACE ANALYSIS SERVICE

(76) Inventor: Seung-Chul Rhee, Seoul (KR)

(21) Appl. No.: 12/993,950

(22) PCT Filed: May 29, 2009
(86) PCT No.: PCT/KR2009/002888

§ 371 Date: Feb. 8, 2011

(30) Foreign Application Priority Data
May 30, 2008 (KR) 10-2008-0050996

(51) Int. Cl. G06K 9/46

(52) U.S. Cl. 382/195

(57) ABSTRACT

The present invention provides a method and apparatus for face analysis service. The method includes a point-designation interface being transmitted to the user client for designating multiple points on an image of the user's face, coordinate information on the multiple points designated on the face image being received, and measured values being determined against the distance ratios or the angles between the predetermined points using the coordinate information. The method is convenient and allows for the objective analysis of a face.

### BACKGROUND OF THE INVENTION

1. Field of the Invention

The present invention relates to a method and apparatus for providing face analysis service and, more particularly, to a method and apparatus which are capable of analyzing a face image of a user by using distance ratios or proportions and angles between predetermined facial points (landmarks).

2. Background of the Related Art

In the past, numerous researches have been executed on regarding the facial attractiveness, which face is more attractive, and people's aesthetic preference of faces.

As everyone knows, the face of a human being is different according to ethnicity, races, generations, and gender differences. Aesthetical evaluation for the face of an individual is not determined by only the independent sizes and shapes of elements of the individual's face. The aesthetical evaluation must be determined by organic harmony and balance between aesthetic facial subunits.

In general, the method of facial analysis is chiefly classified into a cephalometry, an anthropometry, and a photogrammetry.

The cephalometry method is chiefly used by plastic surgeons in order to predict and evaluate results before and after aesthetic plastic surgeries. Steiner, Jarabak, Ricketts, Downs, and McNamara (that is, facial analysis methods using cephalometry) are performed by using a skull base as a reference point. However, the methods have a problem because it has the inaccuracy of the reference point. Furthermore, the methods have lots of problems in that the improvement of a facial aesthetic configuration is sometimes insufficient because the reference data cannot be universally applied and the improvement of dental occlusion is too much primarily considered during the process of preparing aesthetic plastic surgery. Besides, the method of cephalometic facial analysis is problematic because an individual may have a different skeletal configuration or different soft tissue distribution. It is well known that cephalometric analysis does not help to reflect the soft tissue structures accurately according to changes in bony structures and the distribution or changes in soft tissue structures planned by cephalometric analysis are very discordant with those of hard tissue structures.

In addition, the methods are disadvantageous in that patients feel cumbersome and a long time is taken for taking the analysis.

The anthropometry is an alternative method of analyzing a face by manually measuring the face of each individual. There were examples in which beautiful faces were analyzed by way of the anthropometrical measurement based on subjects for a beauty contest. However, the method could not present aesthetically ideal, attractive, or pleasing target values desired by plastic surgeons or the public because the data were based on statistical results from average ordinary. Furthermore, the method is problematic in that it is cumbersome in actual clinical circumstances because the same repeated manual measurement must be performed on each patient.

The method of photogrammetry is a method using the photography and a camera. The method is commonly performed because people commonly use a digital camera with the development of digital image processing technology.

However, the conventional method of photogrammetry requires strict photographic standardization because it's result may vary according to the type of a camera used, the distance between a face and a camera, illumination, and differences of depth of focus. Furthermore, the method is problematic in that distortion may occur in a process of enlarging or reducing an image.

Among the above facial analysis methods, the photogrammetry seems to be the most convenient method. There is a need for developing a new method of face analysis capable of accurately analyzing the face without need of the standardization of photographs or the distortion of an image.

Meanwhile, a cosmetic surgeries using the conventional facial analysis methods has the following problems:

Firstly, though beauty of a person's face differs according to races, ethnicity, and gender characteristics, the conventional method of facial analysis performed in plastic surgery do not take a racial, an ethnical, and epochal characteristics into consideration because most of them follow the Westernized aesthetic criteria or norms.

Secondly, though a beautiful face is different from an average face in current cosmetic surgeries, an average face is the criterion in a step of planning the surgical operation. This is contrary to the original object of a cosmetic surgery; to make a face more beautiful and natural.

Furthermore, in the conventional method of facial analysis, after taking cephalometric film so that the size of a face on the radio graph is identical with an actual facial size of a person, the facial aesthetic features are diagnosed by measuring an absolute length, distance or angles. However, the way to measure the absolute length or distance is not correct because the size of a face of a person, the size of a brain of a person, the thickness of a facial skeleton of a person, and the like have unique characteristics for every individual. Moreover, the absolute measurement may have a possibility that they may induce a uniform cosmetic surgery in disregard of an individual's pattern of facial feature, or ethnic or racial characteristics.

Meanwhile, most of people who wish to have cosmetic surgeries decide plastic surgeries on the basis of extremely subjective judgments for their faces. Also, surgeons tend to evaluate others' faces on the basis of personal medical experiences and personal aesthetic decisions. Furthermore, the surgeons perform a plastic surgery on the basis of such subjective evaluation and perform the operations according to what kind of aesthetic plastic surgery that a patient wants without special facial analysis.

It has been known that 17% or more of people who want rhinoplasty undergo the surgery despite the fact that they have nothing aesthetic problems in their noses. A case where a person has a wrong self body image unlike his actual body status is called a body dysmorphic disorder. It has been known that there are many persons who have a wrong conception of facial aesthetic among people who want a plastic surgery.

The wrong self body image is called perceptional illusion. In case where a plastic surgery is performed on the basis of such perceptional illusion, a result after the operation is not natural, but produces an artificial appearance. Accordingly, some patients are not satisfied with one cosmetic surgery because they do not think they become beautiful after the operation. Also, addictions of plastic surgeries lead many patients to some serious problem, such as repeated operation at the same aesthetic facial subunits.

As a simple and objective method capable of analyzing a face has not yet been developed, consequently, patients or surgeons have evaluated aesthetics of faces on the basis of their experiences or their decisions. Furthermore, there are many cases in which surgeons or patients have different aesthetic opinions on the same face because they have different subjective aesthetic preference. Surgeons tend to recommend patients to undergo plastic surgeries which is familiar or acquainted with the surgeons.

### SUMMARY OF THE INVENTION

Accordingly, the present invention has been made in view of the above problems occurring in the prior art, and it is an object of the present invention to propose a method and apparatus for providing face analysis service, which are capable of accurately analyzing a user's face.

It is another object of the present invention to provide a method and apparatus for providing face analysis service, which are capable of providing different face analysis results according to races and gender.

It is yet another object of the present invention to provide a method and apparatus for providing face analysis service, which are capable of analyzing a face without a complicated standardization task and distortion in face image analysis.

Furthermore, it is still yet another object of the present invention to provide a method and apparatus for providing face analysis service, which are capable of providing not only a partial analysis result, but also a general attractiveness analysis result for a user's face.

Furthermore, it is further yet another object of the present invention to provide a method and apparatus for providing face analysis service, in which a user does not need to directly visit a hospital. That is, a user can be provided with objective evaluation results of his face by only attaching his face image files through a computer.

To achieve the above objects, according to a preferred embodiment of the present invention, there is provided a method for providing face analysis service, by a server connected to user client terminals over a network, comprising the steps of:
(a) transmitting a point designation interface for designating a plurality of points in face images of a user to the user client terminal;
(b) receiving coordinate information about the plurality of points designated in the face images by the user client terminal; and
(c) calculating measurement values for at least one of a distance ratios and angles between predetermined points on the basis of the coordinate information of the plurality of points.

According to another aspect of the present invention, there is provided a method for providing face analysis service, by a server connected to user client terminals over a network, comprising the steps of:
(a) receiving face images, attached by a user, from the user client terminal;
(b) storing coordinate information about a plurality of points designated in the face images; and
(c) calculating measurement values for at least one of distance ratios and angles between predetermined points on the basis of the coordinate information of the plurality of points.

Furthermore, according to yet another aspect of the present invention, there is provided a computer-readable recording medium on which a program for performing the methods are recorded.

Furthermore, according to still yet another aspect of the present invention, there is provided an apparatus for providing face analysis service, comprising:
an interface output unit for outputting a point designation interface for designating a plurality of points in face images of a user;
a coordinate information storage unit for storing coordinate information about the plurality of points designated in the face images; and
a face analyzer for calculating a measurement value for at least one of a distance ratio or proportion and angle between predetermined points on the basis of the coordinate information.

### BRIEF DESCRIPTION OF THE DRAWINGS

Further objects and advantages of the invention can be more fully understood from the following detailed description taken in conjunction with the accompanying drawings in which:

FIG. 1 is a diagram schematically showing the construction of a system for providing face analysis service according to a preferred embodiment of the present invention;

FIG. 2 is a diagram showing a gender and race selection interface according to an embodiment of the present invention;

FIG. 3 is a diagram showing an information registration interface according to an embodiment of the present invention;

FIG. 4 is a diagram showing a point designation interface according to an embodiment of the present invention;

FIG. 5 is a diagram showing an example of output when a point is selected according to an embodiment of the present invention;

FIG. 6 is a diagram showing front face points according to an embodiment of the present invention;

FIG. 7 is a diagram showing side face points according to an embodiment of the present invention;

FIG. 8 is a diagram showing a detailed construction of a face analysis server according to an embodiment of the present invention;

FIG. 9 is a table defining distance ratios according to an embodiment of the present invention;

FIG. 10 is a table defining angles according to an embodiment of the present invention;

FIG. 11 is a flowchart illustrating an example of a general schematic process of a method of providing face analysis service according to the present invention;

FIG. 12 is a flowchart illustrating an example of point designation process according to the present invention;

FIG. 13 is a diagram showing an example of attractiveness statistical results according to an embodiment of the present invention;

FIG. 14 is a diagram showing Pearson correlation coefficients between attractiveness evaluation values of the public and attractiveness measurement values according to the present invention; and

FIG. 15 is a diagram showing nonparametric correlations between attractiveness evaluation values of the public and attractiveness measurement values according to the present invention.

### DETAILED DESCRIPTION OF EMBODIMENTS

The present invention may be modified in various ways and may have several embodiments. Specific embodiments of the present invention are illustrated in the drawings and described in detail. However, the present invention is not intended to be limited to the specific embodiments, and it should be understood that the present invention includes all modifications, equivalents, or substitutions which fall within the spirit and technical scope of the present invention. The same reference numbers will be used throughout the drawings to refer to the same or like parts.

In case where one element is described to be “connected” to the other element, the one element may be directly connected to the other element, but it should be understood that a third element may exist between the two elements.

Hereinafter, preferred embodiments of the present invention are described in detail with reference to the accompanying drawings.

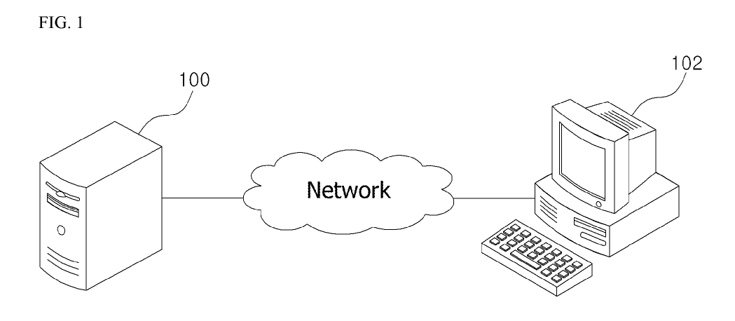

FIG. 1 is a diagram schematically showing the construction of a system for providing face analysis service according to a preferred embodiment of the present invention.

As shown in FIG. 1, the system according to the present invention may include a face analysis server 100 and a user client 102 connected to the face analysis server 100 over a network.

Here, the network may include the Internet, a wired network including a dedicated line, and wireless networks including a wireless Internet, a mobile communication network, and a satellite communication network.

The user client 102 is a terminal connected to the network and configured to analyze and process information provided by the face analysis server 100. Any terminal capable of outputting an interface for the following face analysis may be used as the user client.

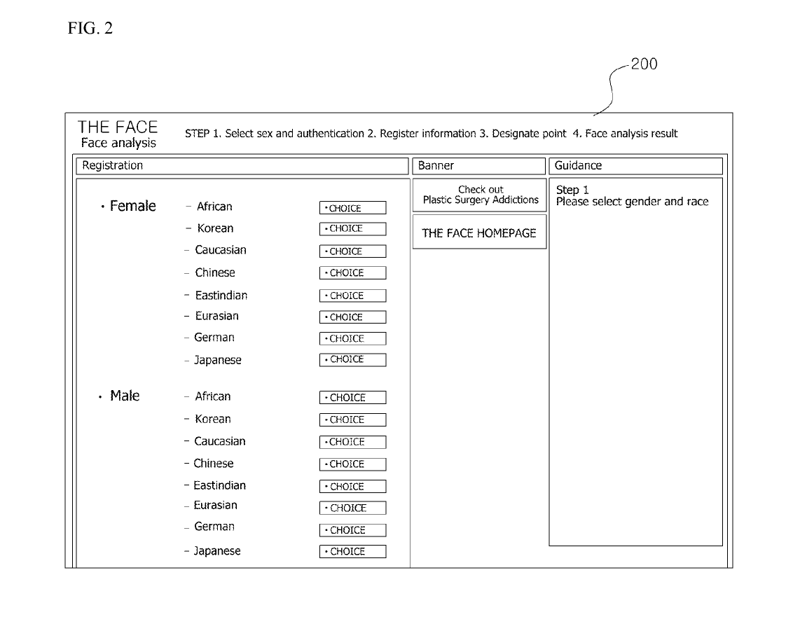

In case where the user client 102 accesses the face analysis server 100, the face analysis server 100 according to the present invention provides the user client 102 with an interface for requesting face analysis service, as shown in FIGS. 2 to 4.

The interface according to the present invention may be provided in the form of a webpage which is executed by a web browser of the user client 102, but may be provided in the form of an independent application program without being limited to the form of a webpage.

Referring to FIGS. 2 to 4, the interface according to the present invention may include a gender and race selection interface 200, an information registration interface 300, and a point designation interface 400 outputted after information registration is completed.

The gender and race selection interface 200 may include a region in which a user selects gender and one of a plurality of races.

As shown in FIG. 2, a user may select for example one of African, Korean, Caucasian, Chinese, East Indian, European, German, and Japanese according to his or her gender.

According to the present invention, the face analysis server 100 analyzes a user's face by using different reference values according to gender and a race.

In face analysis according to the present invention, “BAPA (Balanced Angular and Proportional Analysis)” means a face photograph analysis method to compare a distance ratio (or proportion) and an angle between points designated in a face image by a user, with a predetermined ideal values or aesthetic pleasing values, based on the standard deviation. The reference values refers to ideal values of distance ratios and angles which are calculated on the basis of face analysis results collected for every gender and race. The reference values are described in more detail below.

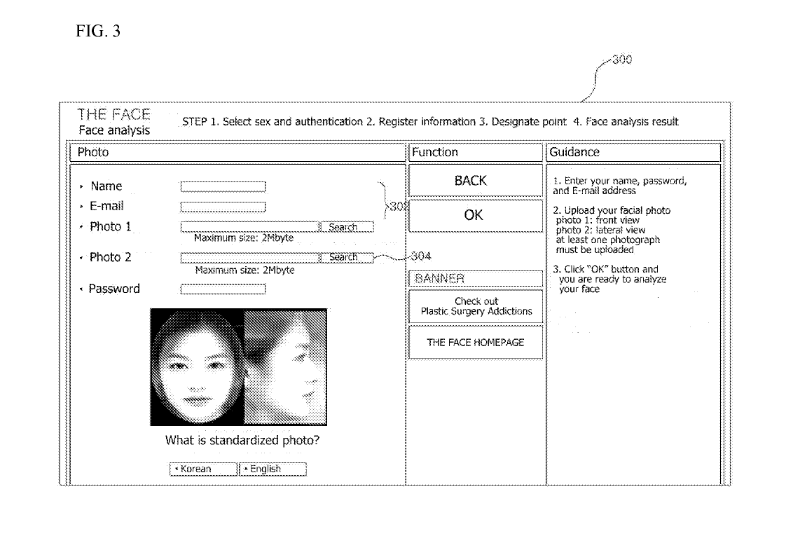

If a user selects gender and a race through an interface, such as that shown in FIG. 2, an interface for information registration is outputted as shown in FIG. 3.

The information registration interface 300 according to the present invention may include a personal information entry (e.g., a name and e-mail) region 302 and a face image attachment region 304.

According to the present invention, front and side face images may be used for face analysis. A user may attach front and side face images as electronic files through the information registration interface 300.

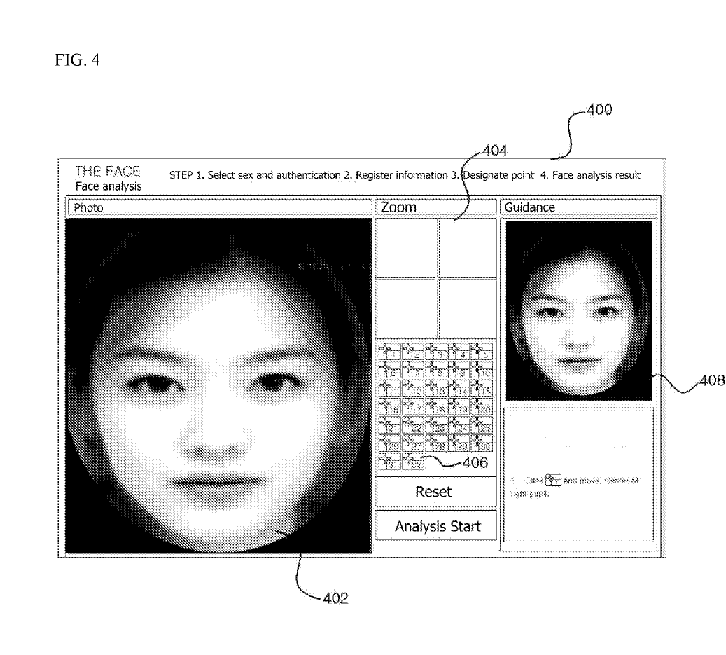

After such information registration is completed, the interface 400 for designating points is outputted as shown in FIG. 4.

As shown in FIG. 4, the point designation interface 400 according to the present invention may include a face image display region 402, an enlargement region 404, a point selection region 406, and a guidance region 408.

The face image display region 402 displays a face image, attached by a user, on the information registration interface 300 in a predetermined resolution.

According to the present invention, when a user selects one of points included in the point selection region 406, a point corresponding to a selected number is outputted to the face image display region 402.

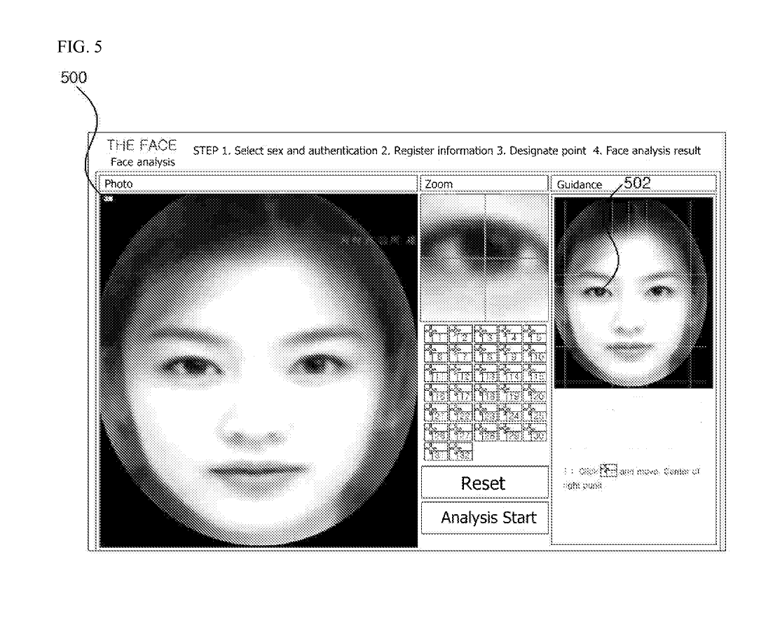

For example, in case where a user selects a point No. 1, a point No. 1 500 is displayed at a predetermined position of the face image display region 402 as shown in FIG. 5. The user can move the point No. 1 to a position to be guided within the guidance region 408 by using a mouse or other input means.

Preferably, such movement of a point in the face image display region 402 may be performed in a mouse click and move manner.

According to the present invention, each point has to be designated at a predetermined position of a face image. To this end, in case where a user selects one of points in the point selection region 406, the selected point may be outputted in a region adjacent to a position to be designated by taking the form of a common face into consideration.

The point designation interface 400 according to the present invention includes the enlargement region 404 for enlarging and displaying a predetermined range of a mouse cursor so that a user designates a point at an accurate position.

A specific portion for designating a point may be checked through the enlargement region 404, and an accurate point may be designated through the enlargement region 404.

Meanwhile, the guidance region 408 is a region which guides a position where a user will designate a point. In case where a user selects one point in the point selection region 406, a designation position 502 of the corresponding point is displayed on a reference face image so that it can be identified (for example, a red point) and outputted along with text.

In case where a user designates a predetermined number of points for each of front and side face images through the above interface, the user client 102 transmits coordinate information for each point to the face analysis server 100.

For accurate face analysis, 32 points may be designated for the front face image and 11 points may be designated for the side face image, according to the present invention.

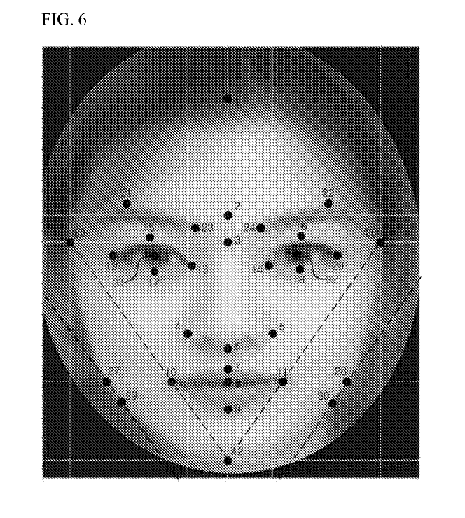

FIG. 6 is a diagram showing front face points according to an embodiment of the present invention. Referring to FIG. 6, the front face points according to the present invention may include the following 32 points:
trigion (tr) 1: a middle point which meets a vertical line in the center of a face and at which hair starts to grow
glabella (g) 2: a point which meets a center vertical line and vertically intersects a horizontal line connecting the centers of eyebrows on both sides
sellion (se) 3: a point where a horizontal line connecting the tops of upper eyelids on both sides intersects a center vertical line
Right ala (R-al) 4: an outermost point of a right wing of the nose (that is, alae nasi)
Left ala (L-al) 5: the outermost point of a left wing of the nose
subnasale (sn) 6: the lowest point where the nose meets the philtrum in the center
labiale superius (ls) 7: an upper point in the center of an upper lip
stomion (sto) 8: a point where an upper lip meets a lower lip in the center
labiale inferius (li) 9: the lowest portion in the center of a lower lip
Right chelion (R-ch) 10: the rightmost outside point of a mouth
Left chelion (L-ch) 11: the leftmost outside point of a mouth
gngnathion (gn) 12: the lowest point in the center of the jaws
Right entocanthion (R-en) 13: the innermost point of a right eye
Left entocanthion (L-en) 14: the innermost point of a left eye
Right palpebrae superius (R-ps) 15: the highest point of a right upper eyelid
Left palpebrae superius (L-ps) 16: the highest point of a left upper eyelid
Right palpebrae inferius (R-pi) 17: the lowest point of a right lower eyelid
Left palpebrae inferius (L-pi) 18: the lowest point of a left lower eyelid
Right exocanthion (R-ex) 19: the outermost point of a right eye (that is, a point where the white pupil is ended)
Left exocanthion (L-ex) 20: the outermost point of a left eye (that is, a point where the white pupil is ended)
Right lateral eyebrow (R-lb) 21: the highest point of a right eyebrow
Left lateral eyebrow (L-lb) 22: the highest point of a left eyebrow
Right medial eyebrow (R-mb) 23: the innermost point of a right eyebrow
Left medial eyebrow (L-mb) 24: the innermost point of a left eyebrow
Right zygion (R-zy) 25: a point where the width of a face is the widest (that is, the outermost point of a right cheekbone)
Left zygion (L-zy) 26: a point where the width of a face is the widest (that is, the outermost point of a left cheekbone)
Right mandibular angle point (R-ang) 27: a point where a middle horizontal line between lips, connecting both oral angles, meets the outline of right jaws
Left mandibular angle point (L-ang) 28: a point where a middle horizontal line between lips, connecting both oral angles, meets the outline of left jaws
Right lateral gonial point (R-latgo) 29: a point where a line parallel to a line, connecting a right cheekbone point and a chin point, meets the outline of the jaws
Left lateral gonial point (L-latgo) 30: a point where a line parallel to a line, connecting a left cheekbone point and a chin point, meets the outline of the jaws
Center of Right pupil (R-p) 31: the center point of a right pupil
Center of Left pupil (L-p) 32: the center point of a left pupil

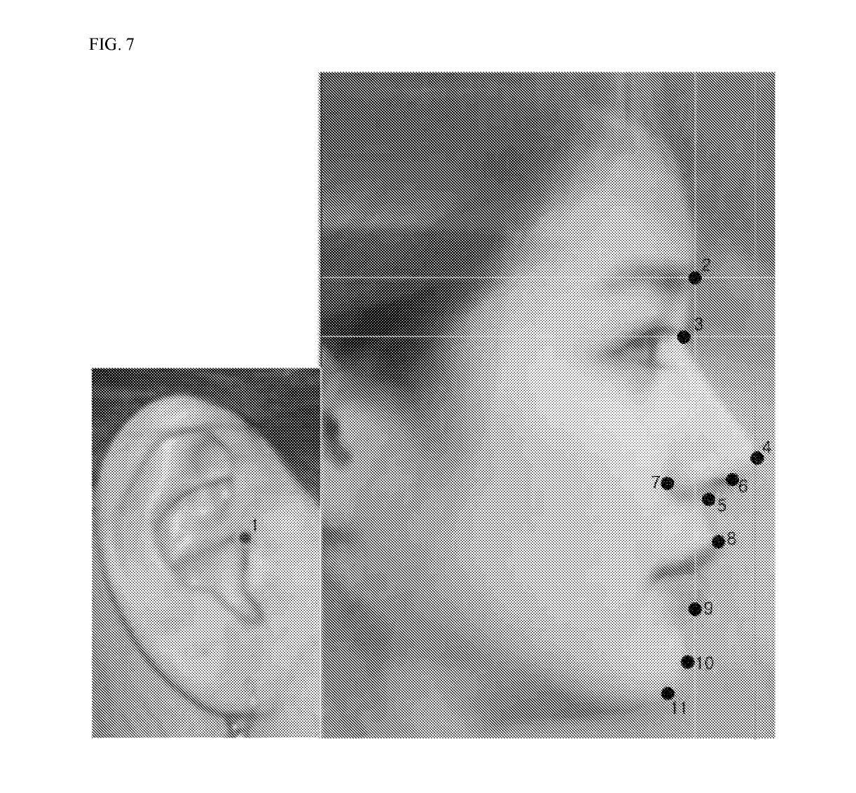

Meanwhile, FIG. 7 is a diagram showing side face points according to an embodiment of the present invention. Referring to FIG. 7, the side face points according to the present invention may include the following 11 points:
tragion (t) 1: a front point at the top of an ear hole (that is, external acoustic meatus)
glabella (g) 2: a protruded point of the forehead where a parallel line passing through a central portion of the eyebrow meets the contour of the forehead
sellion (se) 3: the innermost point in the contour formed by the nose and the forehead
pronasale (prn) 4: the foremost point of an end of the nose
subnasale (sn) 5: the highest and innermost point where the nose meets the philtrum
columella breakpoint (c) 6: a middle point between a subnasal point and the end point of the nose
ala curvature point (ala) 7: a point where the wings of the nose, the most protruded portion of the nose, and a cheek portion meet together
labiale superius (ls) 8: a point where an upper lip meets an end of the philtrum (that is, the uppermost portion)
labiale inferius (li) 9: the lowest portion of a lower lip (that is, a point where the jaws are started)
pogonion (pg) (10): the foremost point of the jaws (that is, a point which is the closest to a vertical line connected to the forehead)
distant chin (dc) (11): a point which is the furthest from a tragion of an ear hole(that is, external acoustic meatus)

After a user has designated all points for the front and side face images through the point designation interface 400, coordinate information about the points is transmitted to the face analysis server 100, and the face analysis server 100 performs face analysis on the basis of the points designated by the user.

Preferably, coordinates for the face image display region 402 may be set. In case where the user has designated the points and requests the face analysis, the coordinate information for each of the points in the face image display region 402 may be transmitted to the face analysis server 100.

The face analysis server 100 performs analysis into the user face on the basis of the coordinate information about the points, received from the user client 102.

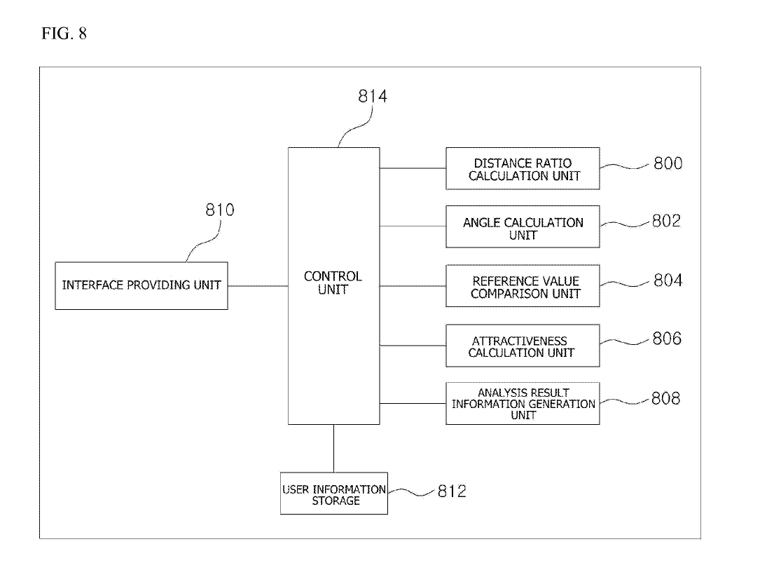

FIG. 8 is a diagram showing a detailed construction of the face analysis server according to an embodiment of the present invention.

As shown in FIG. 8, the face analysis server 100 according to the present invention may include a distance ratio calculation unit 800, an angle calculation unit 802, a reference value comparison unit 804, an attractiveness calculation unit 806, an analysis result information generation unit 808, a user information storage unit 810, an interface providing unit 812, and a control unit 814.

When the coordinate information for each of the points is received from the user client 102, the distance ratio calculation unit 800 and the angle calculation unit 802 calculate distance ratios (or distance proportions) and angles between the points on the basis of a predetermined point.

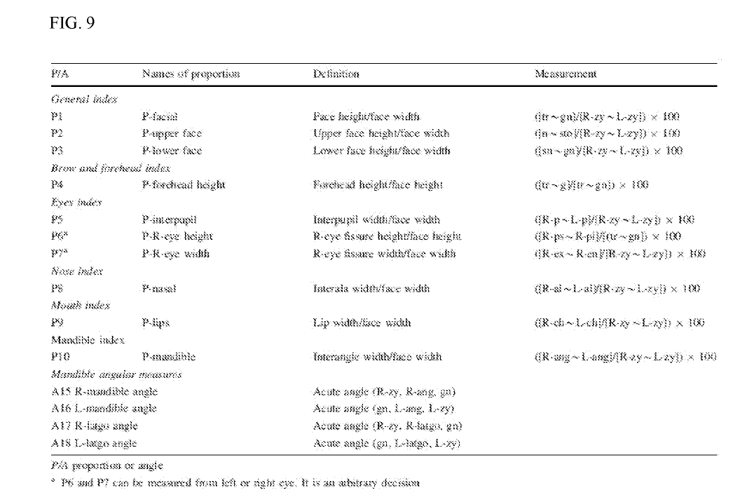

As shown in FIG. 9, the distance ratios according to the present invention are defined as 14 kinds of ratios, such as P1 to P14. The distance ratio calculation unit 800 first calculates each distance between predetermined points.

Straight-line distances between two predetermined points are calculated through such calculation. After the straight-line distances for each point are calculated, the distance ratios, such as P1 to P14, are calculated.

For example, in order to calculate the distance ratio P1, the distance ratio calculation unit 800 may perform a process of calculating the straight-line distance between a point tr(1) and a point gn(12) and the straight-line distance between a point R-zy(25) and a point L-zy(26) and then multiplying a value, obtained by dividing them, by 100.

The above distance ratio P1 corresponds to a distance ratio between the height of the face and the width of the face in terms of the distance ratio between the points.

In this manner, the distance ratio calculation unit 800 calculates the straight-line distances between the two points used in the distance ratios P2 to P14 and calculates the distance ratios P2 to P14 on the basis of the two straight-line distances.

That is, according to the present invention, in order to calculate one defined distance ratio, 4 points are required.

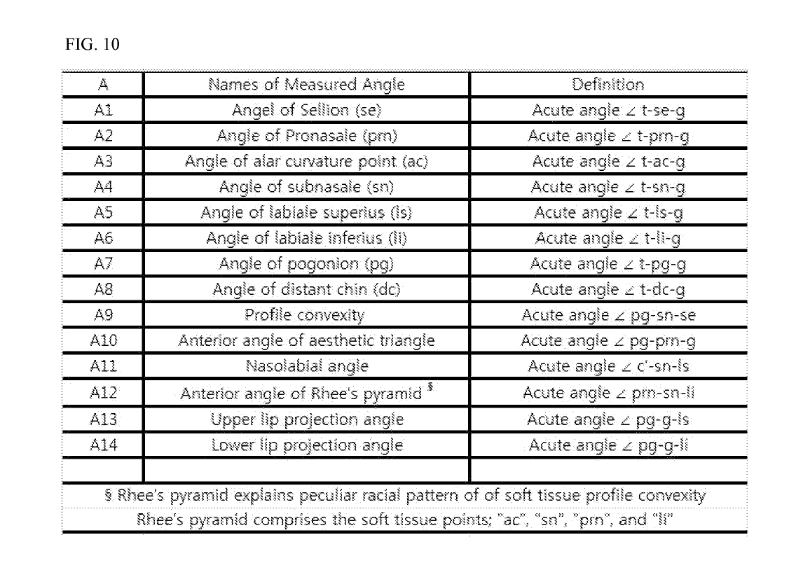

Meanwhile, as shown in FIG. 10, the angles according to according to the present invention are defined to be A1 to A14. The angle calculation unit 802 calculates the angles A1 to A14 by using three predetermined points.

For example, the angle A1 may be defined as the angle of sellion. The angle calculation unit 802 calculates an acute angle between a point t(1), a point se(3), and a point g(2) defined by a user.

As described above, the angle calculation unit 802 calculates the predetermined angles A1 to A14 by using three of the points designated by the user.

The distance ratio and angle according to the present invention is aesthetically defined as an important factor. It does not require the standardization of capturing conditions, and also there is no significant distortion resulting from the enlargement and reduction of an image.

The reference value comparison unit 804 compares the calculated distance ratio and angle with predetermined reference values.

Here, the reference values are values ideally defined for the distance ratios P1 to P14 and the angles A1 to A14 and may be aesthetical target values for every facial part which are calculated on the basis of data for a beauty collected for every race.

The reference values according to the present invention may be inputted to the face analysis server 100 by an operator and modified according to a change of the times on the basis of data subsequently collected.

Furthermore, according to the present invention, standard variations may be set up on the basis of the reference values of the distance ratios and angles. The reference value comparison unit 804 compares the distance ratios and angles, calculated through the face image of a user, and the reference values within the range of the standard variations.

According to the present invention, since the meaning of the distance ratios and angles has already been defined, analysis results for a specific part of the face of a user may be provided through comparison of the reference values.

For example, in case where, for the angle A1 defined as the height of the ridge of the nose, the reference value is defined to be 11.5 and the standard variation is defined to 0.5, if the angle A1 for the face image of a user falls within the range of 11° to 12° through comparison of the reference values, an analysis result, indicating that “the height of the ridge of your nose has the same harmony and balance as that of the best beauty in an average Korean”, may be provide to the user. Meanwhile, in case where the angle A1 is less than 11°, an analysis result, indicating that “the height of the ridge of your nose is lower than that of the best beauty in an average Korean from a viewpoint of the harmony and balance of your face”, may be provide to the user. In case where the angle A1 is more than 12°, an analysis result, indicating that “the height of the ridge of your nose is higher than that of the best beauty in an average Korean from a viewpoint of the harmony and balance of your face”, may be provide to the user.

According to the present invention, a message indicating a comparison result of the reference values for the distance ratios P1 to P14 and the angles A1 to A14 may be previously stored. Upon face analysis, a message corresponding to a comparison result of the reference values may be transmitted to the user client 102 as analysis result information.

Meanwhile, the face analysis server 100 according to the present invention may perform not only partial comparison, but also general harmony and balance for the face image of a user.

When there is a request made by a user or after a user has designated points, the attractiveness calculation unit 806 calculates a general attractiveness (harmony) for the face of the user.

Here, the attractiveness may include attractiveness for each of a front face and a side face.

According to the present invention, the attractiveness calculation unit 806 calculates the attractiveness by using the measured values, the reference values, the standard variations, and weights for the distance ratios and angles of the face image of a user.

Here, the weights are numeral values obtained by examining the degree in which the eyes, nose, mouth, and face form of a face contribute a general attractiveness. The weight according to the present invention may set to each of the distance ratios P1 to P14 and the angles A1 to A14 and differently set according to gender and races.

The attractiveness for a front face according to the present invention may be calculated by the following Equation 1:

Front Attractiveness=100−{[ABS(P1−C1)/D1×E1+[ABS(P2−C2)/D2×E2+ . . . +[ABS(P14−C14)/D13×E14]+10 [Equation 1]
where P1 to P4 indicate the measurement values of the distance ratios between the predetermined points, C1 to C14 indicate the reference values for the P1 to P14, D1 to D14 indicate the standard variations for the P1 to P14, and E1 to E14 indicate the predetermined weights for the P1 to P14.

Meanwhile, the attractiveness for the side face may be calculated by using the following Equation 2:

Side Attractiveness=100−{[ABS(A1−C1)/D1×E1+[ABS(A2−C2)/D2×E2+ . . . +[ABS(A14−C14)/D13×E14]+5 [Equation 2]
where A1 to A14 indicate the measurement values of the angles between the predetermined points, C1 to C14 indicate the reference values for the A1 to A14, D1 to D14 indicate the standard variations for the A1 to A14, and E1 to E14 indicate the predetermined weights for the A1 to A14.

The calculation of the attractiveness using the weights for each of the distance ratios and angles has been described above.

However, the present invention is not limited thereto, and the attractiveness may be calculated without assigning the weights to all the distance ratios and angles. That is, the weights may be set to 1 for all the distance ratios and angles. In this case, in calculating the attractiveness, the influence of the weights may not be taken into consideration.

Meanwhile, in calculating the attractiveness, an effect of the tone of color of a face must be taken into consideration. In the present invention, the influence of a tone of color of a face is considered to be the same as the attractiveness. It is assumed that a value according to a tone of color is the same excluding the calculation of the attractiveness.

In calculating the attractiveness according to the present invention, a calculated attractiveness value of the best beauty may be 90 points in the front face and 95 points in the side face. Accordingly, a final attractiveness measurement value can be calculated by adding 10 points to the front face and 5 points to the side face in the total attractiveness.

The analysis result information generation unit 808 generates information about the analysis results of the reference values according to the distance ratios and angles and the attractiveness, calculated as above.

The generated analysis results are sent to the user client 102.

Meanwhile, the user information storage unit 810 stores personal information inputted by a user, attached face image files, and analysis results for the face images of the corresponding user.

When there is a request from the user client 102, the interface providing unit 812 transmits interfaces, such as that shown in FIGS. 2 to 5, to the user client 102.

The control unit 814 performs a general control process for providing face analysis service at the request of a user.

Meanwhile, in the above embodiments, it has been described that the face analysis server 100 placed at a remote place from a user performs face analysis on the basis of information received from the user client 102.

However, the face analysis service according to the present invention may be installed in a computer in the form of an independent application program. The independent application program may output interfaces, such as that shown in FIGS. 2 to 5, at the request of a user and calculate distance ratios and angles after a user has designated points.

Furthermore, with database for reference values and standard variations, an analysis result message for a specific part of a user may be outputted, and attractiveness may be calculated by using at least one of calculated distance ratios, angles, reference values, standard variations, and weights.

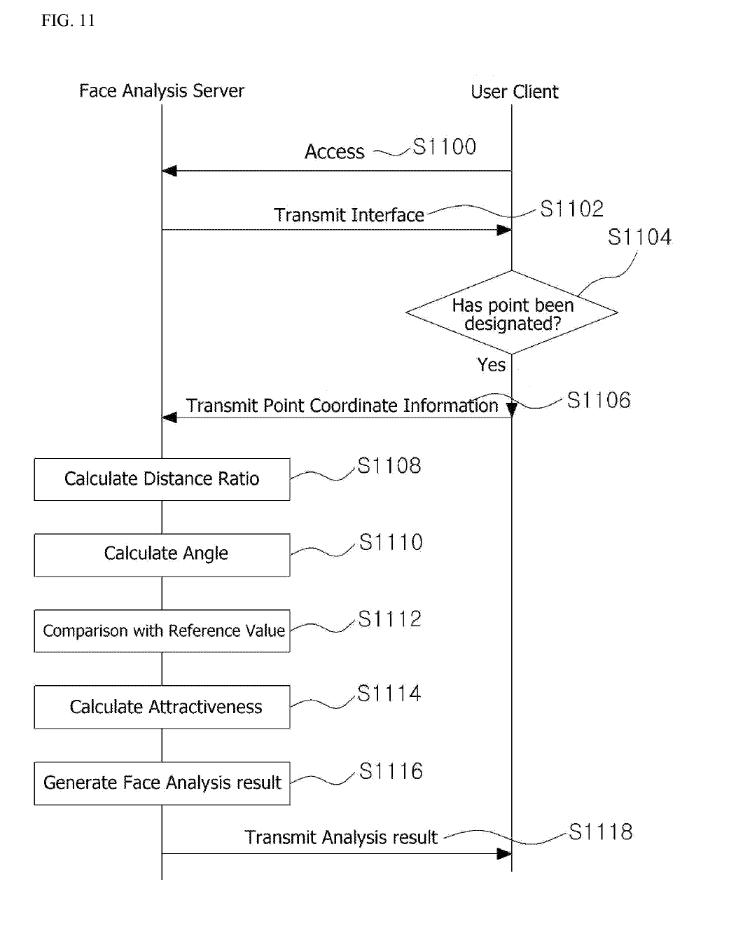

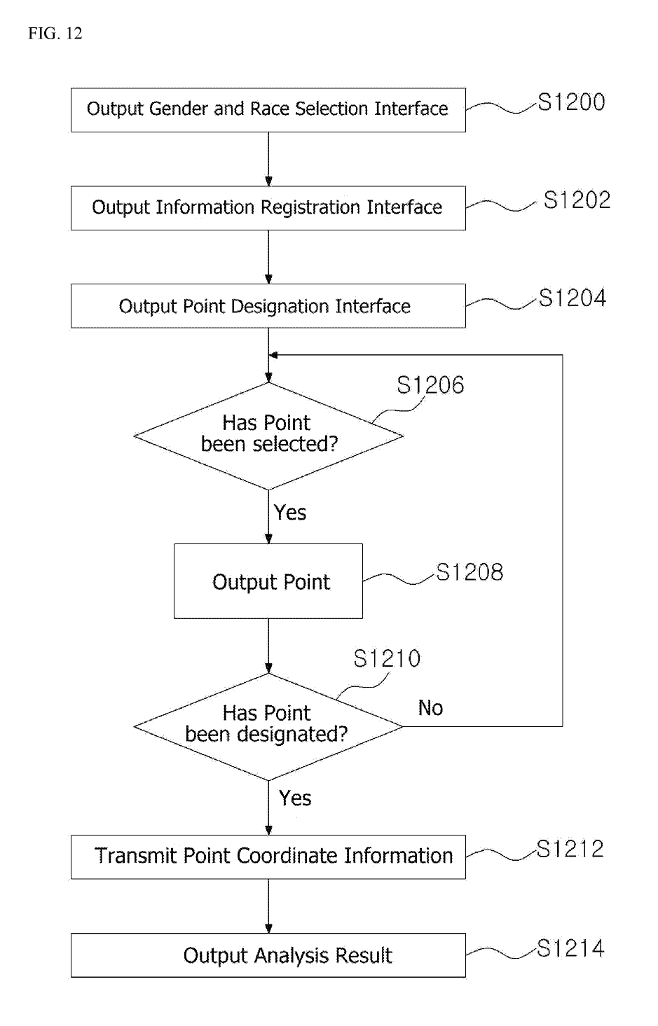

Hereinafter, a process for providing face analysis service according to the present invention is described in detail in connection with embodiments of FIGS. 11 and 12.

FIG. 11 is a flowchart illustrating an example of a general schematic process for providing face analysis service according to the present invention.

Referring to FIG. 11, in case where the user client 102 accesses the face analysis server 100 (step 1100), the face analysis server 100 transmits an interface for requesting face analysis service to the user client 102 (step 1102).

As described above, the interface according to the present invention may include the gender and race selection interface, the information registration interface, and the point designation interface.

Here, the face analysis server 102 may sequentially transmit a next interface after a user' selection or input is completed. However, the present invention is not limited thereto, and a plurality of the interfaces may be transmitted in advance to the user client 102, some preferable interfaces may be output sequentially according to the request of the user at the user client 102.

After the designation of points for attached face images is completed through the point designation interface (step 1104), the user client 102 transmits information about point coordinates to the face analysis server 100 (step 1106).

The face analysis server 100 calculates distance ratios for the predetermined points in the front and side faces on the basis of the point coordinate information (step 1108) and calculates angles (step 1110).

As described above, the distance ratios and angles are calculated by using the predetermined points, and the distance ratios are calculated with respect to predetermined distance ratios P1 to P14, and the angles are calculated with respect to predetermined ratios A1 to A14.

When the distance ratios and angles are calculated, the face analysis server 100 compares measurement values for the distance ratios and angles with previously stored reference values within the range of standard variations (step 1112) and then calculates attractiveness for the entire face of the user (step 1114).

The face analysis server 100 generates user face analysis result information through the steps S1112 to S1114 (step 1116) and transmits the analysis result information to the user client 102 (step 1118).

According to the present invention, the face analysis is performed on the basis of reference values for gender and a race selected by a user. Furthermore, in calculating attractiveness, accurate face analysis can be performed according to gender and a race of a corresponding user because weights for factors affecting the attractiveness are used.

FIG. 12 is a flowchart illustrating an example of a point designation process according to the present invention.

FIG. 12 is described in terms of a process performed by an application program, such as a web browser installed at the user client 102, or of steps performed by the user client 102, for convenience of description.

Referring to FIG. 12, the user client 102 outputs the gender and race selection interface (step 1200). After a user' selection is completed, the user client 102 outputs the information registration interface (step 1202).

When the user completes input work such as name and e-mail address input, face image files attachment, and password input through the information registration interface, the user client 102 outputs the point designation interface (step 1204)

The user client 102 outputs, when the user selects a predetermined point on the point designation interface (step 1206), the selected point on the face image display region (step 1208).

The user can move the point by using a mouse and move the point to a predetermined position of the face image according to guidance in the guidance region.

After the designation for predetermined points is completed (step 1210), the user client 102 transmits coordinate information about each of the points to the face analysis server 100 (step 1212).

The user client 102 outputs an analysis result received from the face analysis server 100 (step 1214).

According to the present invention, distance ratios and angles between the points can have minimum error occurred by capturing conditions. Also, they are such data that not are occurred distortion through the enlargement and reduction of a captured face image file.

A user can be provided with a general analysis result for his face by only transmitting face images to which points have been designated to a remote server. In addition, the user can know his face on the basis of not a subjective decision, but an objective ground.

Meanwhile, it has been described that a user directly designates predetermined points on a face image through the point designation interface.

However, in front and side face images of the present invention, each point may be automatically designated.

In general, positions of eyebrows, eyes, a nose, and a mouth in the human face are placed within a predetermined range. Accordingly, points for each of front and side faces may be automatically designated by analyzing points with varying color, such as skin color, the eyebrows, the eyes, the nose, and the mouth.

Furthermore, a user may only enter personal information and attach face images through the information registration interface. When the face analysis server 100 receives the attached face images, an operator may designate points for the face images, perform face analysis, and transmit an analysis result to the user client 102.

It was confirmed that the calculation of attractiveness according to the present invention has high correlations with attractiveness felt by the public for a specific face.

To this end, attractiveness for 16 photographs before and after an operation was evaluated out of 100 points with respect to the public 164 (for example, men—68 persons, women—96 persons, an average age—32.41±9.83, 77 persons in their twenties, 54 persons in their thirties, 21 persons in their forties, and quinquagenarian—12 persons).

Next, subjective attractiveness evaluation for 164 persons and attractiveness calculation results using Equation 1 and Equation 2 according to the present invention were statistically analyzed (e.g., SPSS 13.0 for windows, USA).

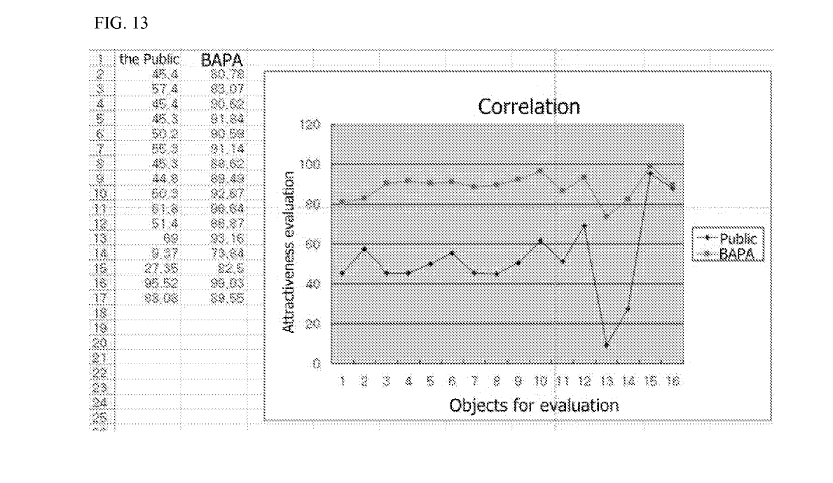

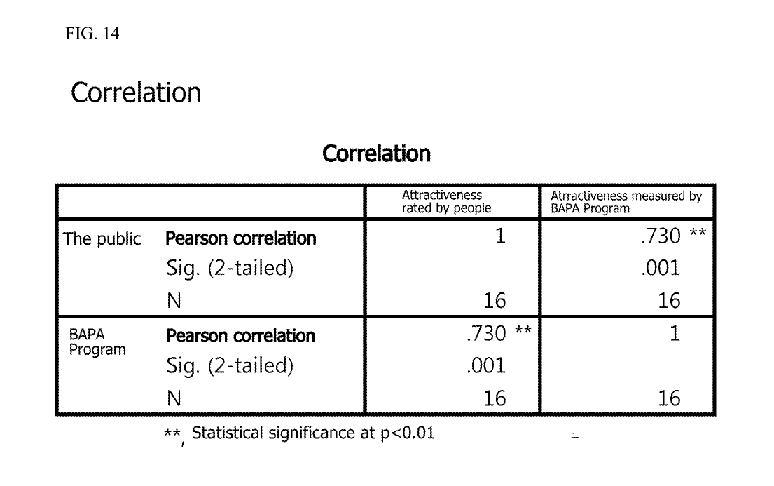

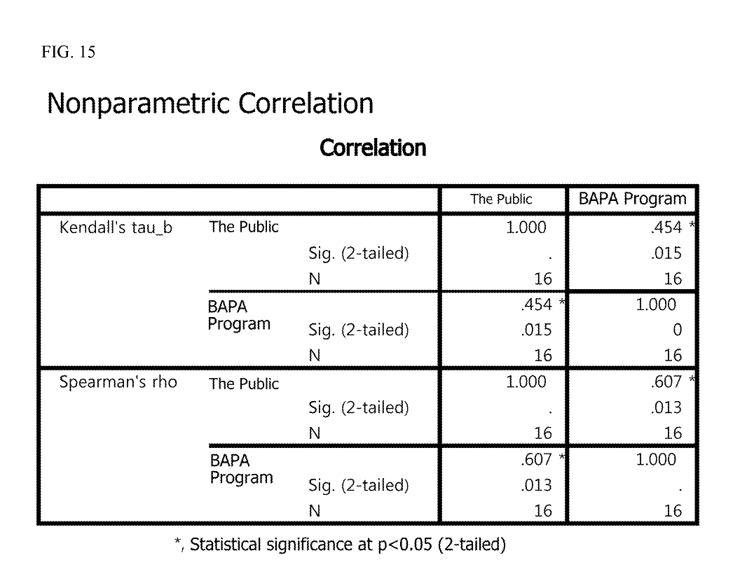

FIG. 13 is a diagram showing an example of attractiveness statistical results according to an embodiment of the present invention. FIG. 14 is a diagram showing Pearson correlation coefficients between attractiveness evaluation values of the public and attractiveness measurement values according to the present invention. FIG. 15 is a diagram showing nonparametric correlations between attractiveness evaluation values of the public and attractiveness measurement values according to the present invention.

From FIG. 13, it can be seen that the attractiveness evaluation values of the public correspond to the attractiveness measurement values according to the present invention.

Furthermore, from FIG. 14, it can be seen that the Pearson correlation coefficient between the attractiveness evaluation value of the public and the attractiveness measurement value is 0.730. In the 99% confidence interval, they have statistical significance (that is, significance level of 1% p=0.001). Accordingly, it can be seen that the attractiveness evaluation value of the public and the attractiveness measurement value have a high correlation.

Furthermore, from FIG. 15, it can be seen that in Spearman nonparametric correlations, a correlation coefficient is 0.607 and a significance level (both sides) is 0.013, and then they have high statistical significance with 95% confidence interval. That is, it can be seen that the attractiveness evaluation value of the public and the attractiveness measurement value also have a high correlation.

According to the present invention, there is an advantage in that an accurate analysis result of a face can be provided by only attaching face images.

Furthermore, there is an advantage in that an analysis result for relative balance or harmony of each of aesthetic factors in a user face can be provided, according to the present invention.

Also, there are advantages in that various data for face images of users can be collected through the Internet and anthropological data can be collected for each times and for each race, according to the present invention.

In addition, a face analysis result is provided by taking not an absolute criterion, but relative aesthetic factors of a patient into consideration, according to the present invention. Accordingly, there is an advantage in that an optimal plastic surgery in which a patient's personality is taken into consideration can be proposed.

Furthermore, there is an advantage of the present invention in that a patient's addiction to plastic surgery can be prevented through objective face analysis.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A method for providing face analysis service, provided by a server connected to user client terminals over a network, comprising:
transmitting a point designation interface for designating a plurality of points in face images of a user to the user client terminal;
receiving coordinate information about the plurality of points designated in the face images by the user client terminal; and
determining measurement values for at least one of distance ratios and angles between predetermined points on the basis of the coordinate information of the plurality of points.

2. The method as claimed in claim 1, wherein the distance ratios and the angles are determined on the basis of different points.

3. The method as claimed in claim 1, wherein the face images comprise at least one of a front face image and a side face image.

4. The method as claimed in claim 1, further comprising:
maintaining information about at least one of reference values and standard variations for the distance ratios and the angles; and
comparing the measurement values and the reference values for the calculated distance ratios and angles within a range of the standard variations.

5. The method as claimed in claim 4, wherein the reference values and the standard variations are differently set according to the user' gender and race.

6. The method as claimed in claim 5, wherein the reference values and the standard variations are differently set according to at least one of Korean, Caucasian, Chinese, East Indian, European, German, and Japanese.

7. The method as claimed in claim 5, further comprising analyzing attractiveness for the user's face by using at least one of the measurement values, the reference values, the standard variations, and weights for the distance ratios and angles.

8. The method as claimed in claim 7, wherein the attractiveness for a front face is determined by Equation below:
100−{[ABS(P1−C1)/D1×E1+[ABS(P2−C2)/D2×E2+ . . . +[ABS(P14−C14)/D13×E14]+10
where P1 to P4 indicate the measurement values of the distance ratios between the predetermined points, C1 to C14 indicate the reference values for the P1 to P14, D1 to D14 indicate the standard variations for the P1 to P14, and E1 to E14 indicate the predetermined weights for the P1 to P14.

9. The method as claimed in claim 7, wherein the attractiveness for a side face is determined by Equation below.
100−{[ABS(A1−C1)/D1×E1+[ABS(A2−C2)/D2×E2+ . . . +[ABS(A14−C14)/D13×E14]+5.
where A1 to A14 indicate the measurement values of the angles between the predetermined points, C1 to C14 indicate the reference values for the A1 to A 14, D1 to D14 indicate the standard variations for the A1 to A14, and E1 to E14 indicate the predetermined weights for the A1 to A14.

10. The method as claimed in claim 7, wherein the weights are numerical values obtained by calculating a degree in which each of the distance ratios and the angles contributes to the attractiveness of the face.

11. The method as claimed in claim 7, further comprising an information registration interface for at least one of the user's selection of gender and a race, the user's entry of personal information, and the user's attachment of front and side face images to the user client terminal.

12. The method as claimed in claim 1, wherein the point designation interface comprises at least one of a point selection region, a face image display region in which the points selected by the user can be moved, an enlargement region in which some of the face image display region is enlarged and displayed, and a guidance region for guiding the designation of the point.

13. The method as claimed in claim 12, wherein the enlargement region enlarges and displays a predetermined range of a mouse cursor position.

14. A method for providing face analysis service, provided by a server connected to user client terminals over a network, comprising:
receiving face images attached by a user from the user client terminal;
storing coordinate information about a plurality of points designated in the face images; and
calculating measurement values for at least one of distance ratios and angles between predetermined points on the basis of the coordinate information of the plurality of points.

15. A computer program product for facilitating face analysis, the computer program product comprising:
a non-transitory, computer-readable storage medium readable by a processor and storing instructions for execution by the processor for performing a method comprising:
transmitting a point designation interface for designating a plurality of points in face images of a user to the user client terminal;
receiving coordinate information about the plurality of points designated in the face images by the user client terminal; and
determining measurement values for at least one of distance ratios and angles between predetermined points on the basis of the coordinate information of the plurality of points.

16. An apparatus for providing face analysis service, comprising:
an interface output unit for outputting a point designation interface for designating a plurality of points in face images of a user;
a coordinate information storage unit for storing coordinate information about the plurality of points designated in the face images; and
a face analyzer for calculating a measurement value for at least one of distance ratios and angles between predetermined points on the basis of the coordinate information.
